(19) United States
(12) Patent Application Publication
(10) Pub. No.: US 2008/0319885 A1
(43) Pub. Date: Dec. 25, 2008

(54) Deposit instruments

(76) Inventors: Joseph L. D'Anna, Westport, CT (US); Mark Garbin, Bronxville, NY (US)

Correspondence Address: FISH & RICHARDSON PC, P.O. BOX 1022, MINNEAPOLIS, MN, 55440-1022, US

(21) Appl. No.: 11/767,289

(22) Filed: Jun. 22, 2007

(51) Int. Cl. G06Q 40/00

(52) U.S. Cl. 705/35

(57) ABSTRACT

Among other things, funds are received at an institution the deposits of which are insured by a third party against loss. In a computer, the received funds are attributed to principal of a single deposit instrument maintained by the institution for the benefit of a depositor. The deposit instrument has a defined maturity time as of which all of the principal will have been returned to the depositor. A computer is used to manage a pattern of principal repayment occasions for the deposit instrument, the occasions occurring prior to the maturity time, so that, at each of the occasions, a specified portion of the principal will be, and an additional non-principal amount may be, paid to the depositor. The pattern of principal repayment occasions is predefined to achieve a generic personal financial objective of a set of depositors that includes the depositor.

### BACKGROUND

This description relates to deposit instruments.

A typical certificate of deposit (CD), for example, is a deposit instrument issued by a bank and represents a time deposit of funds that may not be withdrawn (without penalty) for a specified period of time. The bank maintains a reserve for the amount of the deposit, by contrast with a demand deposit (such as a money market, savings, or checking account) that may be withdrawn at any time and requires no reserve.

A simple CD pays a fixed rate of interest that is higher than for a demand deposit. The depositor receives interest in periodic payments before the maturity date and the principal at maturity. Early withdrawals of principal may be permitted upon the request of the depositor, subject to a withdrawal penalty.

Up to a certain amount of principal (e.g., $100,000 per depositor) of deposits held by a bank, including the principal and accrued interest on CDs, are insured against loss by the Federal Deposit Insurance Corporation (FDIC).

Some CDs provide additional features. For example, market-linked or equity-linked CDs pay the depositor amounts that provide a rate of return on the value of the principal that is based on a performance of an observable reference asset or index (for example, a stock market index such as the Standard & Poor's 500). In some cases, there is a guaranteed minimum rate of return at maturity.

Some CDs permit a depositor (within limits and when certain conditions are met) to deposit additional funds in a CD or request special distributions free of early withdrawal penalties.

At maturity of a typical CD, if the depositor wants to re-deposit the principal in a CD, he is subject to a possibly sharp change in the annual dollar return available on the new CD compared to the one that has reached maturity (sometimes called a re-investment risk).

An investor can reduce the re-investment risk by buying a single long-term CD (say ten years) having a fixed interest rate. Another approach is to deposit funds in a ladder of CDs such that respective CDs in the ladder mature at different times and have different rates that in combination will yield a constant annual dollar return to the depositor. At least one bank offers a ladder certificate that has rungs that mature on different dates to reduce re-investment risk.

Some credit unions offer credit union amortizing certificates, which are time deposit investments that can be viewed as a variation of a mortgage backed bond and amortizes principal as a function of prepayment speed. Credit union certificates are not guaranteed by the FDIC.

Some banks in Canada issue deposit notes for which some payments made to the depositor are considered as return of principal to take advantage of certain Canadian tax laws. The deposit notes are not equity or market linked and require depositor intervention to determine the level of return of principal.

Insurance companies offer variable annuities with a guaranteed minimum withdrawal feature. The insurance holder can direct a premium to be invested in a set of mutual funds and deposit options with a guaranteed ability to receive a return of the premium in fixed payments over time. At any time, the holder may cancel the policy in return for value related to the investment performance of the premium minus withdrawals, fees, and penalties. The policies are a credit obligation of the issuing insurance company, secured by the company's general account. They typically do not benefit from any third-party guarantee.

Bank instruments that are based on deposits of the bank's customers and the banks that issue them typically are not subject to securities regulations that apply to equities and other kinds of non-deposit securities.

### SUMMARY

In general, in an aspect, funds are received at an institution the deposits of which are insured by a third party against loss. In a computer, the received funds are attributed to principal of a single deposit instrument maintained by the institution for the benefit of a depositor. The deposit instrument has a defined maturity time as of which all of the principal will have been returned to the depositor. A computer is used to manage a pattern of principal repayment occasions for the deposit instrument, the occasions occurring prior to the maturity time, so that, at each of the occasions, a specified portion of the principal will be, and an additional non-principal amount may be, paid to the depositor. The pattern of principal repayment occasions is predefined to achieve a generic personal financial objective of a set of depositors that includes the depositor.

Implementations may include one or more of the following. The institution includes a bank. The third party includes a governmental agency. The single deposit instrument includes a certificate of deposit. The defined maturity time includes a single date. The single deposit instrument is one of a type of deposit instruments and the type is one of a range of types of deposit instruments offered by the institution to depositors. The principal repayment occasions occur periodically. The principal repayment occasions do not occur through the period after the funds are received and before the maturity time. Just before the maturity time, some of the principal remains to be paid to the depositor. The computer is controlled by the institution. The funds are received from an intermediary that obtains the funds from the depositor and sends them to the institution.

The additional non-principal amount includes interest. The interest includes a fixed percentage of the principal. The interest includes a varying percentage of the principal. The additional non-principal amount is based on a reference asset. The reference asset includes a market index. The reference asset includes an equity. The reference asset includes a mutual fund. The reference asset includes a futures contract. The reference asset includes a spot price or rate of a commodity.

More than half of the principal of the single deposit instrument is paid to the depositor prior to the maturity time. The no additional non-principal payment is made prior to the maturity time. A final non-principal amount is paid at the maturity time. The final non-principal amount includes interest. The final non-principal amount is based on a reference asset.

At least a part of one or more of the specified portions of the principal to be paid on the principal repayment occasions is deferred at the election of the depositor. At least a part of one or more of the specified portions of the principal to be paid on the principal repayment occasions is reinvested at the election of the depositor. The principal paid to the depositor on the principal repayment occasions is paid without penalty.

In general, in an aspect, funds are received from an investor at an intermediary entity to be applied as principal to a single deposit instrument to be maintained as a deposit by an institution for the benefit of the investor. The deposits of the institution are insured by a third party against loss. The funds are forwarded from the intermediary entity to the institution. Information related to the investor, the funds, and the single deposit instrument to the institution is electronically forwarded for use in a computer that will (a) attribute the funds to the principal of the single deposit instrument, the deposit instrument having a defined maturity time as of which all of the principal will have been returned to the depositor, and (b) manage a pattern of principal repayment occasions for the deposit instrument. The occasions occur prior to the maturity time. At each of the occasions, a specified portion of the principal will be, and an additional non-principal amount may be, paid to the investor. The pattern of principal repayment occasions is predefined to achieve a generic personal financial objective of a set of investors that includes the investor. The intermediary entity receives compensation in connection with receiving and forwarding the funds. The single deposit instrument includes a private labeled product marketed by the intermediary entity.

In general, in an aspect, funds are received at an institution the deposits of which are insured by a third party against loss. In a computer, the received funds are attributed to principal of a deposit instrument maintained by the institution for the benefit of a depositor. The deposit instrument has a defined maturity time as of which all of the principal will have been returned to the depositor. The principal and an additional non-principal amount that is based on a change in value of an interest in one or more identified mutual funds are repaid to the depositor.

These and other aspects and features and combinations of them can be expressed as methods, apparatus, systems, business methods, program products, means for performing functions, and in other ways.

Other aspects, features, and advantages will become apparent from the following description and the claims.

### DESCRIPTION

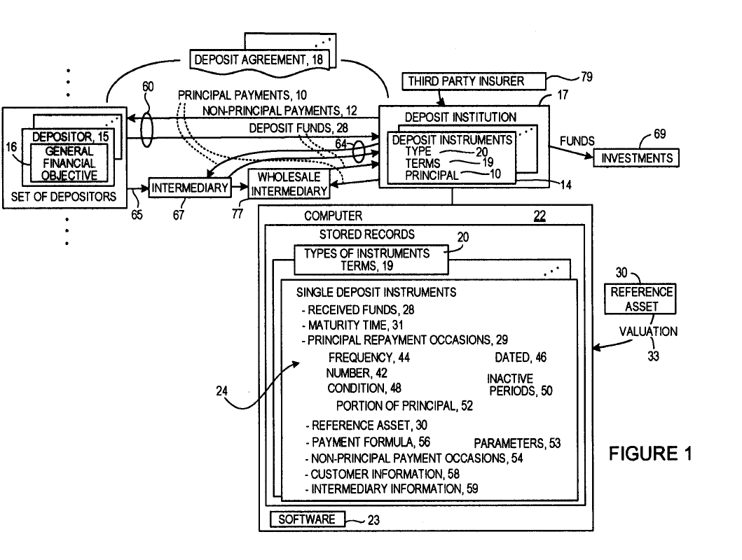

FIG. 1 is a block diagram.

As shown in FIG. 1, by appropriately managing a pattern of repayments of principal 10 (and in some cases additional non-principal amounts 12) of an appropriately structured single deposit instrument 14 (e.g., an amortizing certificate of deposit or A-CD), the depositor 15 can better achieve his financial objectives 16 and other goals.

Although, in the following discussion, we sometimes refer to specific examples of certain general features, each of the features can be implemented in a wide variety of other ways. Our use of the examples is not meant to limit the breadth of the new features described here.

The A-CD 14 may be issued by a deposit institution 17 (e.g., a bank) in accordance with the terms of a deposit agreement 18 which defines the features of the instrument. A variety of different types 20 of deposit instruments can be offered to serve various and changing market demands. The general terms 19 of each type 20 of A-CD are defined by a bank product developer and stored in a computer 22 (e.g., a computer under the control of the bank). The specific parameters 24 for a particular A-CD 26 of a given type and for a specific depositor are generated at the time of the deposit of funds 28 from the depositor, are reflected in a specific deposit agreement 18 that adds the specific parameters to a template agreement, and are stored in the computer 22. The computer 22 uses software 23 to manage the servicing of and accounting for each of the A-CDs during its existence to assure that the terms of the deposit agreement are met.

Each A-CD held by a depositor is characterized by the features and parameters agreed upon between the depositor and the bank.

One feature of an A-CD is a pattern of principal repayment occasions 29. On each of the principal repayment occasions, a specified portion (for example, a stated percentage or a specific dollar amount) of the principal 10 (that is, of the original funds deposited by the depositor) is paid to the depositor. In some examples, the repayment occasions may be spaced at regular intervals during the entire term of the CD up to its maturity time 31, and the same portion of the principal may be paid on each occasion.

Non-principal amounts 12 may or may not also be paid on each of the principal repayment occasions, for example, a fixed interest amount or percentage or an amount represented by a current value 33 of a reference asset 30. The non-principal amounts can be paid in a pattern. For example, the pattern of interest payments can be deferred until after more than 50% of the principal has been returned to the depositor.

In some examples, only principal payments are made during the term of the instrument, that is, between the time when the original funds are deposited (the inception) and the maturity time; and no non-principal amounts are paid during that period. Upon maturity, the remaining principal and a non-principal amount are paid. In this way, the depositor is assured of receiving equal regular payments of a planned amount rather than payments that vary. The regular payments can be more (in some cases, considerably more) than the amount that has accrued based on a stated interest rate or on an appreciation in the value of the reference asset.

A wide variety of different features and parameters may apply to a given A-CD. Information related to the features and parameters is stored in the computer for use in managing the A-CD.

The stored information can include the maturity time 31 (e.g., a specific maturity date) and the number 42, frequency 44, specific dates 46, and conditions 48 of each of (or groups of) the principal repayment occasions. Inactive periods 50 can be provided during the term of the A-CD during which there are no principal repayment, for example, for a defined period at the beginning, middle, or end of the term.

The portion of principal 52 to be paid to the depositor on the principal repayment occasions can be defined. The portion can be the same for all of the occasions, or follow a mathematical variation, or be set at arbitrary different amounts for the respective occasions. The portion can be expressed as dollars or other values, as a percentage of the principal, or in other ways.

Parameters 53 of the non-principal amounts to be paid on one or more of the non-principal payment occasions can be defined in terms of the measure on which the amounts are to be based (for example, a fixed interest rate or the value of a reference asset or some combination of the two or other factors), and whether or not a non-principal amount will be paid on a given occasion. A formula for calculating the payment to be made 56 can be included.

Identification of the account and the depositor and a wide variety of demographic information 58 about the depositor may also be defined. Information about intermediaries and wholesale intermediaries 59 is also stored.

Whether or not non-principal amounts are paid on one or more occasions before the maturity date, certain non-principal amounts can be paid on the maturity date. Those non-principal amounts can be based on a wide variety of measures, for example, financial measures such as simple fixed interest rates applied to the principal, or changing values of reference assets. The reference assets could be traditional financial assets such as particular equities or other securities, groups of equities, market indexes, spot prices or rates of commodities, futures contracts, and any other assets that have values that can be observed regularly and reliably.

Even though the A-CD includes payments of principal to the depositor during the term of the CD, not all principal will be paid prior to the maturity time. At all times during the term, a well-defined amount of principal will be on deposit with the bank and the bank will have guaranteed payment. Partly for that reason, the A-CD will be a deposit that is insurable by the FDIC.

A variety of advantages can be achieved by the arrangement illustrated in FIG. 1 (or of certain implementations of what is shown in FIG. 1).

As a bank guaranteed, insured deposit, the A-CD is simple, low cost, easy to understand and manage, and secure. In examples in which the instrument is linked to a reference asset, the A-CD offers upside potential to the depositor.

In examples in which equal amounts of principal (but no non-principal amounts) are paid on periodic occasions before the maturity date, the depositor has the convenience and confidence of receiving periodic distributions that are independent of fluctuations of the market and can be significantly higher than traditional CDs. Reinvestment risk can be materially reduced. The bank can easily offer similar such CDs (as a group or type) that have different rates of periodic distribution with otherwise similar or identical terms. The complexity and effort of managing traditional laddered CDs can be reduced or eliminated. A long-term investor with short-term liquidity needs can arrange simpler and extended matching of cash flow and expenses. The bank can use such CDs to access substantially longer term funding than from traditional CDs.

In examples in which the CDs include non-principal payments that are based on the changing value of a reference asset, the bank may offer better participation in market appreciation through longer terms and better time diversification. Cash flows from the CDs can offset periodic tax liabilities. The payments tied to the value of the reference asset can be formulated so that the CD economics mirror a long-term investment 80 in an index, basket of stocks, mutual fund, or other asset, from which (guaranteed) systematic withdrawals are taken.

Principal payments to the depositor during the term of the A-CD, except for interest that is imputed by the Internal Revenue Service, are not taxed. Therefore there is a tax deferral aspect to the A-CDs discussed here.

By receiving principal in smaller amounts over time, instead of a lump sum at maturity, the depositor can reduce the re-investment risk and dollar cost average the re-investments.

Although, in some examples discussed above, the deposit institution is a bank, other institutions could issue single deposit instruments having amortized principal. Such instruments could be insured as deposits by relevant third parties. The institution could be a credit union or savings and loan association, among others. The insuring third party could be the Federal Savings and Loan Insurance Corporation (FSLIC) or the National Credit Union Administration (NCUA) through the National Credit Union Share Insurance Fund (NCUSIF). In countries outside the United States other deposit institutions and insuring third parties could be used.

Among the possible channels for the distribution of A-CDs are two shown on FIG. 1. One channel 60 is from the bank directly to its customers. The other channel 62 is through an intermediary 67, e.g., a broker.

In the case of the direct channel, payments of principal and non-principal amounts from the bank to the depositor will typically be made to another account held by the depositor with the bank, such as a checking account. The bank retains servicing, reporting, and monitoring tasks some or all of which are carried out automatically by the computer and software or with the aid of the computer and software.

In the case of the intermediary channel, the intermediary or even another party 77 is the one that maintains a customer relationship 65 with the depositor (such as a broker-dealer relationship with an investor). The bank makes payments and provides reporting to the intermediary or other party on an aggregated basis, and the intermediary passes the payments and reporting to the customer. In some contexts, the intermediary could private label the A-CD in a way that characterizes it as a product of the intermediary that is supported by services of the bank, rather than as a product of the bank.

Because the payments that are made to the depositor during the term of the deposit instrument and prior to the maturity time are of principal and need not include any interest, the issuing bank has a very broad flexibility in the types of A-CDs that it offers, the number of different ones, and the relationships among the different types. In addition, the bank may offer very broad flexibility to the depositor to make choices about the payments made during the term of the A-CD. Among other things, an A-CD could be structured to replicate any ladder that an investor could otherwise construct using conventional CDs or market index CDs, and with other advantages not provided by the conventional CDs.

Among other things, the number, timing, amounts, and frequency of the principal payments can be selected with complete freedom as can the periods during the term when principal payments are to be made. The payment stream can be crafted to suit the interests of individual depositors or groups of depositors in any way that serves market demand. In addition, the parameters for different A-CD product types can be changed easily and quickly over time to suit changing market conditions.

In some examples, the principal payments will be determined as a fixed percentage of the original principal per year and paid annually. In other cases, the principal payments may be rising, declining, delayed, or frontloaded and spaced at even or uneven intervals. For example, the payments could be scheduled to provide a deferral period of n years, followed by annual payments of 100%/(T-n) of the original principal for (T-n) years (e.g., a 15-year product that pays nothing for 5 years and then 100%/(15-5yrs)=10%/year for 10 years).

In some implementations, the depositor could be offered an option to defer and reinvest principal payments, although the computer management of such deposit instruments would be more complicated than for the simple A-CDs described earlier.

In some cases, a depositor may be permitted to deposit additional funds during the term of the A-CD at some cost to the depositor in terms of the overall economics of the instrument.

In an interest rate environment characterized by low interest rates that are flat out to many years, the A-CD could be a long-term equity-linked instrument with short-term, guaranteed liquidity in the form of principal payments.

Conversely, if the yield curve had a steeply upward or downward slope, the A-CD could provide access to a higher yield with a shorter maturity than would otherwise be possible. In an artificial example, if rates are at 3% in years 1 to 5 and then rise linearly to 13% by year 10%, a bank could offer a conventional 5-year CD at an APY of 3% and an A-CD (with average life of 5 years), all else equal, at an APY of 6%.

To be a bank time deposit that qualifies for FDIC coverage, a well defined principal balance may be required to be on deposit at all times, up to and including the maturity time. The amount of principal remaining at maturity will be determined, in the case where no re-investment of payments is permitted prior to maturity, as simply: (original deposit amount)—Total (payments prior to maturity). If re-investment of payments is permitted, then the principal amount on deposit due at maturity will increase.

In some examples, the A-CD could be based on performance of a market index and the distribution rate could be ratcheted up or down to make the distributions variable on a global basis (i.e., in the same way for every depositor in A-CDs of that type).

Although the maturity time will usually be a fixed date, it is possible that implementations could provide for a variable maturity date, e.g., one that could not go beyond a predefined latest possible maturity date without a re-investment event.

More generally, the terms of a given A-CD or of a type of A-CD would be developed to fit market circumstances and to provide products that will appeal to depositors or sets of them at a given time.

In one scenario for implementing the A-CD, a principal payment schedule and interest calculation would be advertised and agreed to in advance with the depositor. If the product is not linked to the value of a reference asset (we sometimes refer to this feature as being market-linked) the interest would be a fixed rate set at maturity. If it is a market-linked product, the non-principal payments would be set according to a pre-determined formula and fixed parameters based on the value of the reference asset. We sometimes refer to the non-principal payments that are based on a reference asset as market interest.

The market interest formula may or may not reference or depend on the amount of principal outstanding over time. In any case, the principal amount on deposit will need to be determinable at any time after inception, during the term, and prior to maturity. In some cases, the principal amount in the future is pre-determined. For instruments that permit re-investment or additional investment, the amount will not be pre-determined, yet will be certain as of each future date, based on investor choices.

A wide variety of different market interest payoff formulas may be used. We describe several examples here.

1. “Bull” pay-off for a growth product linked to the S&P 500. At maturity, the product offers a capital return of 100%, plus the absolute value of 400% of the fall in a reference basket over the investment period, subject to a maximum overall return of [145-147]%. If the basket rises by no more than 7% over the investment period, the capital return is 100%. Otherwise, the capital return is 100% minus 1% for every 1% rise in the basket, subject to a minimum capital return of 50%.

2. “Bull/Bear” payoff for a growth product linked to the S&P 500. At maturity, if the index level is equal to or greater than [85.50-86.50]% of the initial level and equal to or less than [113.50-114.50]% of the initial level throughout the investment period, the product offers a capital return of 100%, plus the absolute value of the rise/fall in the index over the investment period. If the index level lies outside the given range at any time during the investment period, the capital return is 100%.

3. “Digital” payoff for a growth product equally linked to Copper, Nickel, Zinc, Crude Oil, and Natural Gas. At maturity, if the basket performance is positive over the investment period, the product offers a capital return of 100%, plus the greater of either a 30% return or 100% of the rise in the basket over the investment period. Otherwise, the product offers a capital return of 100%.

4. “Rainbow” payoff for a growth product linked to the S&P 500, DJ Eurostoxx 50 and Nikkei 225. Every year, the investor may terminate the product prior to maturity. At maturity, the basket performance is weighted 60%, 30%, and 10% for the best, second best, and third best component, respectively. The product offers a capital return of 100%, plus the greater of 21% or the sum of the basket performances. The final level of each component in the basket is calculated as the average of quarterly readings taken throughout the investment period.

5. “Range” payoff for a growth product linked to the S&P 500. At maturity, if the index level is equal to or greater than [85.50-86.50]% of the initial level and equal to or less than [113.50-114.50]% of the initial level throughout the investment period, the product offers a capital return of 100%, plus the absolute value of the rise/fall in the index over the investment period. If the index level lies outside the given range at any time during the investment period, the capital return is 100%.

As mentioned earlier, a class of several A-CD products of a given type could be offered at one time, for example, a series of 10-year A-CDs linked to a mutual fund that pay a distribution rate over time and then principal outstanding plus 100% participation in uncapped market interest (computed based on fund total return performance, less an annual protection fee, weighted by principal outstanding over time) at maturity. The different products of this type could include: (Product 1) annual payment of 5% of principal; at maturity, 50% of principal plus market interest, (Product 2) 7% of principal as an annual payment; at maturity, 30% of principal plus market interest, (Product 3) 10% of principal as an annual payment; market interest at maturity, (Product 4) No annual principal payment first 5 years then 10% of principal per year; at maturity 50% of principal plus market interest, and (Product 5) Annual principal payments starting at 5% and rising by an inflation factor of 1.03× each year for 16 years (e.g. {5.0%, 5.15%, 5.30%, . . . ,7.8%}); market interest at year 16.

Another series of A-CDs could offer variations on interest-based CDs, all with relatively similar terms, because adjusting the principal payments can be done, in many cases, without significant changes to the other terms of the CD.

A single A-CD can be used to replicate the principal and maturity structure of any depositor constructed ladder, which simplifies the effort. Not only can the depositor do in one transaction and one instrument what might have required ten or twenty conventional instruments, but also the depositor can reduce the effort of reinvesting and tracking the deposits.

In addition, the A-CD permits the bank to consider the entire ladder as one diversified obligation, thus, all else equal, the key terms to the depositor (interest rate) in an A-CD version may be increased at the same net economic cost to the bank.

In an example of an amortizing optimal-ladder A-CD, a $100,000 deposit in a 4.75% A-CD would have an optimal-ladder principal payment schedule over ten years of: 8.8%, 9.0%, 9.3%, 9.6%, 9.8%, 10.1%, 10.4%, 10.7%, 11.0%, and 11.3%.

In another example—an amortizing, equity-linked CD—the $100,000 deposit would provide fixed, after-tax distributions and market upside potential at maturity, using an even principal payment schedule for ten years of 10% each year. (These are similar to but do not precisely equal the deposit fractions for the optimized CD ladder described above.)

Such an A-CD would offer uncapped capital appreciation potential using market linked interest realized at maturity.

Because long terms (e.g., 10 years) are more likely to be interesting to depositors in A-CDs than in conventional CDs (having maturities of no longer than 5 to 7 years), the bank is likely to get access to substantially longer term funding using A-CDs. Depositors should consider A-CDs with average maturity of 5-7 years of equal or greater attraction to traditional CDs of 5-7 year maturity in terms of liquidity, risk, and return. A-CDs with 5-7 year average maturity can have final maturities of 10 to 15 years. Thus, the issuance of A-CDs can provide the bank with deposits up to 15 years in final duration from depositors who would otherwise not participate in term deposits of greater than 7 years.

The market-linked A-CD also offers the prospect for better market participation because of the longer maturities that can be used and the increased time diversification. The differential between the rates charged by banks for loans to borrowers and the rates paid on CDs compounds to significant amounts (in economic present value) for CDs that have longer maturities. For example, if the bank's discount rate for long term funding is the CD rate+1%, the volatility of the index is 16%/yr standard deviation, and the dividend yield of the reference asset is 2%/yr, then the cost of funding the principal payments is less for a 10-year A-CD ($0.7535 at inception per $1 of principal to be paid) than it is for a 5-year CD ($0.7651). All else equal, a longer term derivative is cheaper to deliver per unit of time than a short-term one because time diversification of market performance observations reduces the overall risk to the bank in hedging the liability. The bank can use these extra savings to enhance a product by raising the minimum guaranteed return at maturity or increasing some multiplier of market interest

Longer term CDs are likely to be better for depositors because, over the long term, most market indices, equities, or other reference assets are expected to return more than traditional CDs. In one example, the internal rate of return (IRR) of a 10-year A-CD is substantially greater (10.3%/yr) than that of a standard CD (7.3%/yr) for the same annual performance of the reference asset (12%/yr). In this example, although both products had an average maturity of about 5 years, the A-CD provided superior IRR at all constant market returns and a minimum return above principal of 9% (total) versus 0% for the traditional CD.

Another advantage of the A-CD is to reduce and defray the tax liability that is created by, for example, a conventional, 5-year equity-linked CD that makes no payments prior to maturity.

The market interest can also be structured so that the economics of the A-CD mirror a long-term investment in an index, basket of stocks, mutual fund, or other reference asset, from which (guaranteed) systematic withdrawals are taken.

The transactions required by the bank to support an A-CD can be conducted as an International Swaps and Derivatives Association (ISDA) swap contract with another bank that is the issuer of the A-CD.

To support the bank's commitment to make the principal and non-principal payments of an A-CD during the term and at maturity time, the bank can deposit and invest 69 the principal through a long-term funding desk to receive a floating rate of interest over time and return of principal at required maturities. To hedge equity or market interest components in CDs, the bank can enter into customized equity swap transactions with an equity derivatives (ED) desk at a bank affiliated institution. The equity swaps become part of the ED's aggregate portfolio of customer-driven derivative liabilities. The ED desk dynamically manages a hedge portfolio (comprised of futures, options, swaps, and long positions in equities, indices, funds, and other instruments) designed to generate cash flows that match the payment obligations.

The value of the reference asset is determined by a formula 56 that is fixed and disclosed prior the offering of the A-CD. The payments represented by the formula will typically be a function of market observables such as a stock prices, index levels, or mutual fund net asset values, or baskets of them, to be recorded at pre-specified dates after issuance and prior to maturity. A simple pay-off (termed a European Call) is based on a single observation of an index level at maturity versus its value at issuance, for example: Payoff=(participation rate)×Max[min guaranteed interest, Index_T/Index_0-1], where participation rate is a leverage factor (generally 100% but possibly more or less), min guaranteed interest is a guaranteed minimum return, Index_T is the observed index value at maturity and Index_0 is the observed index value at issuance. A slightly more complex but common pay-off (termed an Asian Call) is based on the average of cumulative returns: Interest=Max[min guaranteed interest, Sum[Index_i/Index_0; i=1 to N]/N−1]. The A-CD product may have early call or acceleration provisions based on formulas of market observables. Also, the market index may be based on the price of a security, its total return, its greatest or least value over a period, the ratio of time it spends inside a range versus outside, its value above or below another market observable, and any of a variety of other measures.

The following table illustrates the terms of an example of an amortizing certificate of deposit.

| Program | Issued under the Rabobank, N.A. Certificate of Deposit Program | | | | | |
|---|---|---|---|---|---|---|
| Dealer/Underwriter | Principal Protected, Index-linked, Amortizing Certificate of Deposit | | | | | |
| Type | | | | | | |
| Index | S&P 500 INDEX (Bloomberg: SPX <INDEX> GO) | | | | | |
| Pricing Date | [Jun. 1, 2007] | | | | | |
| Issue Date | [Jun. 1, 2007] | | | | | |
| Final Maturity Date | [Jun. 1, 2017, 10 years after Issue Date] | | | | | |
| Deposit Amount per CD | [USD 1,000] | | | | | |
| Deposit Amount | I. [USD 5,000,000] | | | | | |
| Business Days | New York | | | | | |
| Amortization Payment | Each annual anniversary of the Pricing Date up to and including the Final Maturity Date, specifically | | | | | |
| Dates | Year number, “y” | 1 | 2 | 3 | 4 | 5 |
| | Amortization Payment | [Jun. 1, 2008] | [Jun. 1, 2009] | [Jun. 1, 2010] | [Jun. 1, 2011] | [Jun. 1, 2012] |
| | Date | | | | | |
| | Year number, “y” | 6 | 7 | 8 | 9 | 10 |
| | Amortization Payment | [Jun. 1, 2013] | [Jun. 1, 2014] | [Jun. 1, 2015] | [Jun. 1, 2016] | [Jun. 1, 2017] |
| | Date | | | | | |

| Amortization Payment | Deposit Amount × [10%] | | | | | | | | | | |
|---|---|---|---|---|---|---|---|---|---|---|---|
| Amount | | | | | | | | | | | |
| Unamortized Principal | On any date prior to Maturity, the Unamortized Principal will equal the original Deposit Amount less the total of all | | | | | | | | | | |
| | Amortization Payments made since inception | | | | | | | | | | |
| Payment at Maturity | Final scheduled Amortization Payment Amount plus Index Interest Amount | | | | | | | | | | |
| Index Interest Amount | Deposit Amount × Index Interest. | | | | | | | | | | |
| Index Interest | An amount, determined at Final Maturity, by the formula | | | | | | | | | | |
| | $Max [ 0 , {\sum }_{y = 1}^{10} {η}_{y} \times {R}_{y} ]$ | | | | | | | | | | |
| | where: | | | | | | | | | | |
| | η_{y}: is fraction of Unamortized Principal outstanding during year “y”, specifically | | | | | | | | | | |
| | Year number, “y” | 1 | 2 | 3 | 4 | 5 | 6 | 7 | 8 | 9 | 10 |
| | η_{y} | 100% | 90% | 80% | 70% | 60% | 50% | 40% | 30% | 20% | 10% |

| | |
|---|---|
| | R_{y}: is the year “y” return of the Index determined by the formula |
| | ${R}_{y} = \frac{{Index}_{y}}{{Index}_{y - 1}} - 100 \%$ |
| | and where: |
| | Index_{y}: is the official closing level of the Index on the Amortization Payment Date number “y,” |
| | Index₀: is the official closing level of the Index on anniversary of the Pricing Date, being [TBD] |
| | 100.00% (USD 1,000) |
| Early Redemption | The CDs may be redeemed at the investor's option every quarter until the CDs reach maturity. The redemptions will |
| Feature: | be at prices established by the bank and may be more or less than original investment value. See “Calculation of |
| | Early Redemption Price” and “Early Redemption Procedure for Holders of CDs” in the Disclosure Statement for a |
| | complete description |
| Form | Book-entry only (Depository Trust Company) |
| Calculation Agent | Rabobank International |
| FDIC Insurance | [The CDs are insured by the Federal Deposit Insurance Corporations to a maximum of USD 100,000 per depositor, |
| | subject to the limitations imposed by law] |
| Survivor's option | At Amortized Par (for example, on Jan. 1, 2011 Amortized Par will be 100% - (3 yrs × 10%/yr) = 70% of Original |
| | Deposit Amount) |
| Governing Law | New York |

The following table illustrates the terms of an example of an amortizing certificate of deposit having a PWSI Payoff.

| Program | Issued under the Rabobank, N.A. Certificate of Deposit Program | | | | | |
|---|---|---|---|---|---|---|
| Dealer/Underwriter | Principal Protected, Index-linked, Amortizing Certificate of Deposit | | | | | |
| Type | | | | | | |
| Index | S&P 500 INDEX (Bloomberg: SPX <INDEX> GO) | | | | | |
| Pricing Date | [Jun. 1, 2007] | | | | | |
| Issue Date | [Jun. 1, 2007] | | | | | |
| Final Maturity Date | [Jun. 1, 2017, 10 years after Issue Date] | | | | | |
| Deposit Amount per CD | [USD 1,000] | | | | | |
| Deposit Amount | [USD 5,000,000] | | | | | |
| Business Days | New York | | | | | |
| Amortization Payment | Each annual anniversary of the Pricing Date up to and including the Final Maturity Date, specifically | | | | | |
| Dates | Year number, “y” | 1 | 2 | 3 | 4 | 5 |
| | Amortization Payment | [Jun. 1, 2008] | [Jun. 1, 2009] | [Jun. 1, 2010] | [Jun. 1, 2011] | [Jun. 1, 2012] |
| | Date | | | | | |
| | Year number, “y” | 6 | 7 | 8 | 9 | 10 |
| | Amortization Payment | [Jun. 1, 2013] | [Jun. 1, 2014] | [Jun. 1, 2015] | [Jun. 1, 2016] | [Jun. 1, 2017] |
| | Date | | | | | |

| Amortization Payment | Deposit Amount × [d]% | | | | | |
|---|---|---|---|---|---|---|
| Amount | | | | | | |
| Unamortized Principal | On any date prior to Maturity, the Unamortized Principal will equal the original Deposit Amount less the total of all | | | | | |
| | Amortization Payments made since inception | | | | | |
| Payment at Maturity | Final scheduled Amortization Payment Amount plus Index Interest Amount | | | | | |
| Index Interest Amount | Deposit Amount × Index Interest. | | | | | |
| Index Interest | An amount, determined at Final Maturity, by the formula | | | | | |
| | $( Deposit Amount ) \times Max [ 0 , {\sum }_{y = 1}^{10} {η}_{y} \times {R}_{y} ]$ | | | | | |
| | where: | | | | | |
| | η_{y}: is fraction of Unamortized Principal outstanding during year “y”, specifically | | | | | |
| | Year number, “y” | 1 | 2 | 3 | 4 | 5 |
| | Unamortized Principal, η_{y} | [1 [symbol] | [100 − d]% | [100 − 2 × d]% | [100 − 3 × d]% | [100 − 4 × d]% |
| | Year number, “y” | 6 | 7 | 8 | 9 | 10 |
| | Unamortized Principal, η_{y} | [1 [symbol] | [100 − 6 × d]% | [100 − 7 × d]% | [100 − 8 × d]% | [100 − 9 × d]% |

| | |
|---|---|
| | R_{y}: is the year “y” return of the Index determined by the formula |
| | ${R}_{y} = \frac{{Index}_{y}}{{Index}_{y - 1}} - 100 \%$ |
| | and where: |
| | Index_{y}: is the official closing level of the Index on the Amortization Payment Date number “y,” |
| | Index₀: is the official closing level of the Index on anniversary of the Pricing Date, being [TBD] |
| Early Redemption | The CDs may be redeemed at the investor's option every quarter until the CDs reach maturity. The redemptions will |
| Feature: | be at prices established by the bank and may be more or less than original investment value. See “Calculation of |
| | Early Redemption Price” and “Early Redemption Procedure for Holders of CDs” in the Disclosure Statement for a |
| | complete description |
| Form | Book-entry only (Depository Trust Company) |
| Calculation Agent | Rabobank International |
| FDIC Insurance | The CDs are insured by the Federal Deposit Insurance Corporations to a maximum of USD100,000 per depositor, subject |
| | to the limitations imposed by law |
| Survivor's option | At Unamortized Principal outstanding (for example, on Jan. 1, 2011, if d = 10% then Unamortized Principal will be |
| | 100% - (3 yrs × 10%/yr) = 70% of Deposit Amount) |
| Governing Law | New York |

[symbol]

indicates data missing or illegible when filed

The following table illustrates the terms of an example of an amortizing certificate of deposit having an Asian payoff.

| Program | Issued under the Rabobank, N.A. Certificate of Deposit Program | | | | | |
|---|---|---|---|---|---|---|
| Dealer/Underwriter | Principal Protected, Index-linked, Amortizing Certificate of Deposit | | | | | |
| Type | | | | | | |
| Index | S&P 500 INDEX (Bloomberg: SPX <INDEX> GO) | | | | | |
| Pricing Date | [Jun. 1, 2007] | | | | | |
| Issue Date | [Jun. 1, 2007] | | | | | |
| Final Maturity Date | [Jun. 1, 2017, 10 years after Issue Date] | | | | | |
| Deposit Amount per CD | [USD 1,000] | | | | | |
| Deposit Amount | [USD 5,000,000] | | | | | |
| Business Days | New York | | | | | |
| Amortization Payment | Each annual anniversary of the Pricing Date up to and including the Final Maturity Date, specifically | | | | | |
| Dates | Year number, “y” | 1 | 2 | 3 | 4 | 5 |
| | Amortization Payment | [Jun. 1, 2008] | [Jun. 1, 2009] | [Jun. 1, 2010] | [Jun. 1, 2011] | [Jun. 1, 2012] |
| | Date | | | | | |
| | Year number, “y” | 6 | 7 | 8 | 9 | 10 |
| | Amortization Payment | [Jun. 1, 2013] | [Jun. 1, 2014] | [Jun. 1, 2015] | [Jun. 1, 2016] | [Jun. 1, 2017] |
| | Date | | | | | |

| | |
|---|---|
| Amortization Payment | Deposit Amount × [d]% |
| Amount | |
| Unamortized Principal | On any date prior to Maturity, the Unamortized Principal will equal the original Deposit Amount less the total of all |
| | Amortization Payments made since inception |
| Payment at Maturity | Final scheduled Amortization Payment Amount plus Index Interest Amount |
| Index Interest Amount | Deposit Amount × Index Interest. |
| Minimum Guaranteed | Minimum Guaranteed Market Performance at Final Maturity will be [MGP]% |
| Market Performance | |
| Index Interest | An amount, determined at Final Maturity, by the formula |
| | $( Deposit Amount ) \times Max [ 100 \% + [ MGP ] \% , \frac{1}{10} {\sum }_{y = 1}^{10} {Perf}_{y} ]$ |
| | where: |
| | Perf_{y}: is the observed, cumulative performance of the Index for the period from Pricing Date until the end of year “y”, |
| | as determined by the formula |
| | ${Perf}_{y} = \frac{{Index}_{y}}{{Index}_{0}}$ |
| | and where: |
| | Index_{y}: is the official closing level of the Index on the Amortization Payment Date number “y,” |
| | Index₀: is the official closing level of the Index on anniversary of the Pricing Date, being [TBD] |
| Early Redemption | The CDs may be redeemed at the investor's option every quarter until the CDs reach maturity. The redemptions will be at |
| Feature: | prices established by the bank and may be more or less than original investment value. See “Calculation of Early |
| | Redemption Price” and “Early Redemption Procedure for Holders of CDs” in the Disclosure Statement for a complete |
| | description |
| Form | Book-entry only (Depository Trust Company) |
| Calculation Agent | Rabobank International |
| FDIC Insurance | The CDs are insured by the Federal Deposit Insurance Corporations to a maximum of USD100,000 per depositor, subject |
| | to the limitations imposed by law |
| Survivor's option | At Unamortized Principal outstanding (for example, on Jan, 1, 2011, if d = 10% then Unamortized Principal will be |
| | 100% - (3 yrs × 10%/yr) = 70% of Deposit Amount) |
| Governing Law | New York |

The following table compares certain features of examples of traditional CDs and A-CDs.

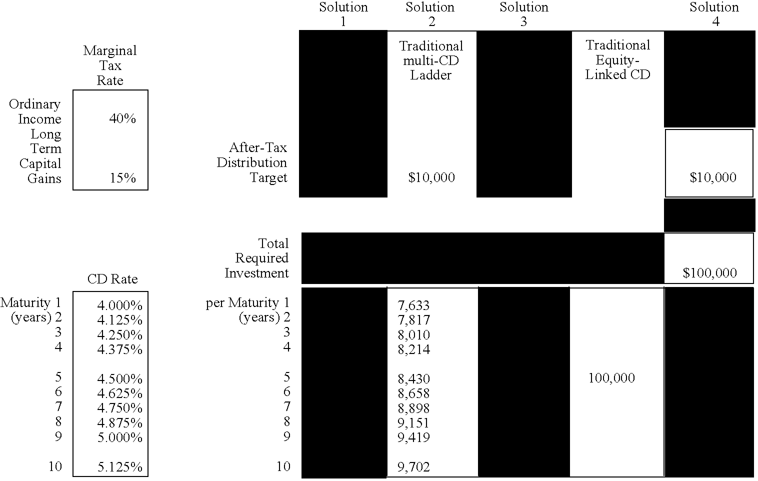

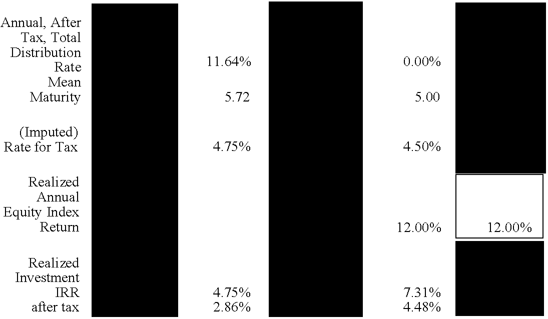

Other implementations are also within the scope of the following claims.

1. A method comprising receiving funds at an institution the deposits of which are insured by a third party against loss,
in a computer, attributing the received funds to principal of a single deposit instrument maintained by the institution for the benefit of a depositor, the deposit instrument having a defined maturity time as of which all of the principal will have been returned to the depositor,
using a computer to manage a pattern of principal repayment occasions for the deposit instrument, the occasions occurring prior to the maturity time, so that, at each of the occasions, a specified portion of the principal will be, and an additional non-principal amount may be, paid to the depositor,
the pattern of principal repayment occasions being predefined to achieve a generic personal financial objective of a set of depositors that includes the depositor.

2. The method of claim 1 in which the institution comprises a bank.

3. The method of claim 1 in which the third party comprises a governmental agency.

4. The method of claim 1 in which the single deposit instrument comprises a certificate of deposit.

5. The method of claim 1 in which the defined maturity time comprises a single date.

6. The method of claim 1 in which the single deposit instrument is one of a type of deposit instruments and the type is one of a range of types of deposit instruments offered by the institution to depositors.

7. The method of claim 1 in which the principal repayment occasions occur periodically.

8. The method of claim 1 in which the principal repayment occasions do not occur through the period after the funds are received and before the maturity time.

9. The method of claim 1 in which, just before the maturity time, some of the principal remains to be paid to the depositor.

10. The method of claim 1 in which the computer is controlled by the institution.

11. The method of claim 1 in which the funds are received from an intermediary that obtains the funds from the depositor and sends them to the institution.

12. The method of claim 1 in which the additional non-principal amount comprises interest.

13. The method of claim 12 in which the interest comprises a fixed percentage of the principal.

14. The method of claim 12 in which the interest comprises a varying percentage of the principal.

15. The method of claim 1 in which the additional non-principal amount is based on a reference asset.

16. The method of claim 15 in which the reference asset comprises a market index.

17. The method of claim 15 in which the reference asset comprises an equity.

18. The method of claim 15 in which the reference asset comprises a mutual fund.

19. The method of claim 15 in which the reference asset comprises a futures contract.

20. The method of claim 15 in which the reference asset comprises a spot price or rate of a commodity.

21. The method of claim 1 in which more than half of the principal of the single deposit instrument is paid to the depositor prior to the maturity time.

22. The method of claim 1 in which no additional non-principal payment is made prior to the maturity time.

23. The method of claim 1 in which a final non-principal amount is paid at the maturity time.

24. The method of claim 21 in which the final non-principal amount comprises interest.

25. The method of claim 21 in which the final non-principal amount is based on a reference asset.

26. The method of claim 1 in which at least a part of one or more of the specified portions of the principal to be paid on the principal repayment occasions is deferred at the election of the depositor.

27. The method of claim 1 in which at least a part of one or more of the specified portions of the principal to be paid on the principal repayment occasions is reinvested at the election of the depositor.

28. The method of claim 1 in which the principal paid to the depositor on the principal repayment occasions is paid without penalty.

29. A method comprising
receiving funds from an investor at an intermediary entity to be applied as principal to a single deposit instrument to be maintained as a deposit by an institution for the benefit of the investor, the deposits of the institution being insured by a third party against loss,
forwarding the funds from the intermediary entity to the institution,
electronically forwarding information related to the investor, the funds, and the single deposit instrument to the institution for use in a computer that will (a) attribute the funds to the principal of the single deposit instrument, the deposit instrument having a defined maturity time as of which all of the principal will have been returned to the depositor, and (b) manage a pattern of principal repayment occasions for the deposit instrument, the occasions occurring prior to the maturity time, so that, at each of the occasions, a specified portion of the principal will be, and an additional non-principal amount may be, paid to the investor, the pattern of principal repayment occasions being predefined to achieve a generic personal financial objective of a set of investors that includes the investor.

30. The method of claim 27 in which the intermediary entity receives compensation in connection with receiving and forwarding the funds.

31. The method of claim 27 in which the single deposit instrument comprises a private labeled product marketed by the intermediary entity.

32. A method comprising
receiving funds at an institution the deposits of which are insured by a third party against loss,
in a computer, attributing the received funds to principal of a deposit instrument maintained by the institution for the benefit of a depositor, the deposit instrument having a defined maturity time as of which all of the principal will have been returned to the depositor,
repaying to the depositor the principal and an additional non-principal amount that is based on a change in value of an interest in one or more identified mutual funds.
